(19) United States
(12) Patent Application Publication
(10) Pub. No.: US 2019/0108551 A1
(43) Pub. Date: Apr. 11, 2019

(54) METHOD AND APPARATUS FOR CUSTOMER IDENTIFICATION AND TRACKING SYSTEM

(71) Applicant: Hampen Technology Corporation Limited, Hong Kong (HK)

(72) Inventors: Felix Chow, Hong Kong (HK); Chiu Wa Ng, Hong Kong (HK); Chun Ho Yip, Hong Kong (HK); Shan Shan Zheng, Hong Kong (HK); How Chun Lau, Hong Kong (HK)

(21) Appl. No.: 15/808,910

(22) Filed: Nov. 10, 2017

Related U.S. Application Data
(63) Continuation-in-part of application No. 15/727,717, filed on Oct. 9, 2017, now Pat. No. 10,061,996.

(51) Int. Cl. G06Q 30/02; G06K 9/00; G06T 7/246; G06T 7/73; G06F 17/30

(52) U.S. Cl. CPC G06Q 30/0269; G06Q 30/0272; G06Q 30/0242; G06Q 30/0255; G06K 9/00255; G06K 9/00268; G06Q 20/20; G06T 7/248; G06T 7/74; G06K 9/00308; G06F 17/30793; G06F 17/3082; G06K 9/00288

(57) ABSTRACT

The present invention provides an automatic identification and tracking method and system for identifying whether a customer is a very important person (VIP), retrieving profile, demographical data and/or point of sale (POS) records of the customer, tracking location of the customer, and sending the retrieved profile and tracked location of the customer to mobile devices of staffs, therefore enhanced services and targeted advertisements can be provided to customers promptly and accurately.

### CROSS-REFERENCES TO RELATED APPLICATIONS

This application is a continuation-in-part of U.S. patent application Ser. No. 15/727,717 filed Oct. 9, 2017; the disclosure of which is incorporated by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to personal identification for advertisement and security purposes. Particularly, the present invention relates to a face recognition method and system to identify customers to provide enhanced services and targeted advertisements.

### BACKGROUND

Many service-oriented industries strive to provide higher quality service or targeted advertising to their big-spending customers classified as very important persons (VIP) with personal attention or at least the impression of personal attention. Often, it is a challenge to a salesperson or receptionist deployed in a business premise to identify every visiting customer and recall their profiles instantly in order to provide tailor-made services to the important customers. Therefore, there is a need for a method and system to automatically identify the important customers and promptly inform staffs of their arrival and profile information such that staffs can provide just-in-time tailor-made services to them.

Face recognition has been known to be an effective way for personal identification. Traditional face recognition systems usually capture the face of a particular subject and match it with a library of previously captured facial images in a one-to-one manner for security or authentication purposes. A challenge in using face recognition systems for customer identification is that the number of customers to be identified at a particular business premise may not be known in advance. Also, it may be required to detect the presence of customers in a particular area of interest and automatically perform personal identification.

Methods and systems have been developed for automatic face recognition. For example, U.S. Pat. No. 9,262,668 discloses a distant face recognition system comprising a primary and a plurality of secondary video cameras provided to monitor a detection area. The primary video camera can detect people present in the detection zone. Data can be then transmitted to a prioritizor module that produces a prioritized list of detected people. The plurality of secondary video cameras then captures a high-resolution image of the faces of the people present in the detection area according to the prioritized list provided by the prioritizor module. The high-resolution images can be then provided to a face recognition module, which is used to identify the people present in the detection area. However, such system would be very expensive to implement as it requires multiple pan-tilt-zoom (PTZ) cameras.

Other techniques have been developed to track visiting guests by face recognition, such as the method disclosed in U.S. Pat. No. 8,750,576. But, the disclosed method lacks the ability to promptly notify of the status of the visiting guest via a mobile communication system. Still other techniques have been developed for providing targeted advertisements based on face clustering. For example, U.S. Pat. No. 8,769,556 discloses a method and apparatus for providing targeted advertisements based on face clustering for time-varying video. During operation, video is continuously obtained of users of the system. Users' faces are detected and measured. Measurements of users' faces are then clustered. Once the clusters are available, advertisements are targeted at the clusters rather than individual users. However, as advertisements are targeted at the clusters rather than the individual users in such type of system, the content of the targeted advertisements cannot be personalized and relating to the targeted audience at the more personal level.

### SUMMARY

It is an objective of the present invention to provide a method and system for automatic customer identification and tracking such that enhanced services and targeted advertisements can be provided to customers promptly and accurately.

In accordance to one aspect of the present invention, an automatic identification and tracking method is provided to identify whether a customer entering a premise, such as a shopping mall or retail store, is a previously registered or remembered customer (or VIP), retrieve profile, demographical data and/or point of sale (POS) records of the customer, track location of the customer, and send the retrieved profile and tracked location of the customer to computing devices configured to be used by sales/service staffs.

In accordance to another aspect of the present invention, the automatic identification and tracking method further comprises displaying targeted advertisements associated with demographical data of the customer in a frontend device to the customer; detecting a plurality of sentiments of the customer watching the targeted advertisements; measuring a dwell time of watching the targeted advertisements by the customer; and performing analysis on effectiveness of targeted advertisements based on the demographic data, the detected sentiments and measured dwell time of the customer.

In accordance to another aspect of the present invention, the automatic identification and tracking method further comprises utilizing a plurality of cameras installed at various locations in the. The various locations include, but not limited to, advertisement displays, signage devices, merchandise shelves, display counters, entrances, and exits. Once a customer is first captured by one of the cameras, regardless of whether she is previously identified and whether she has been previously registered, the customer is assigned a temporary unique identifier. The customer is tracked by the plurality of cameras as she roams around the premise with information including path of movement and dwell time at each location recorded. This information is then sent to computing devices configured to be used by sales/service staffs, and analyzed for the customer's interests in goods and services and shopping preferences. Consequently, the staffs can make use of the analysis results to better market goods and services, and provide a personalized shopping experience to each customer.

### BRIEF DESCRIPTION OF THE DRAWINGS

Embodiments of the invention are described in more detail hereinafter with reference to the drawings, in which

FIG. 1 illustrates a flowchart of an automatic identification and tracking method in one embodiment of the present invention; and

FIG. 2 illustrates an automatic identification and tracking system in one embodiment of the present invention.

### DETAILED DESCRIPTION

In the following description, methods and systems for automatic customer identification and tracking are set forth as preferred examples. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

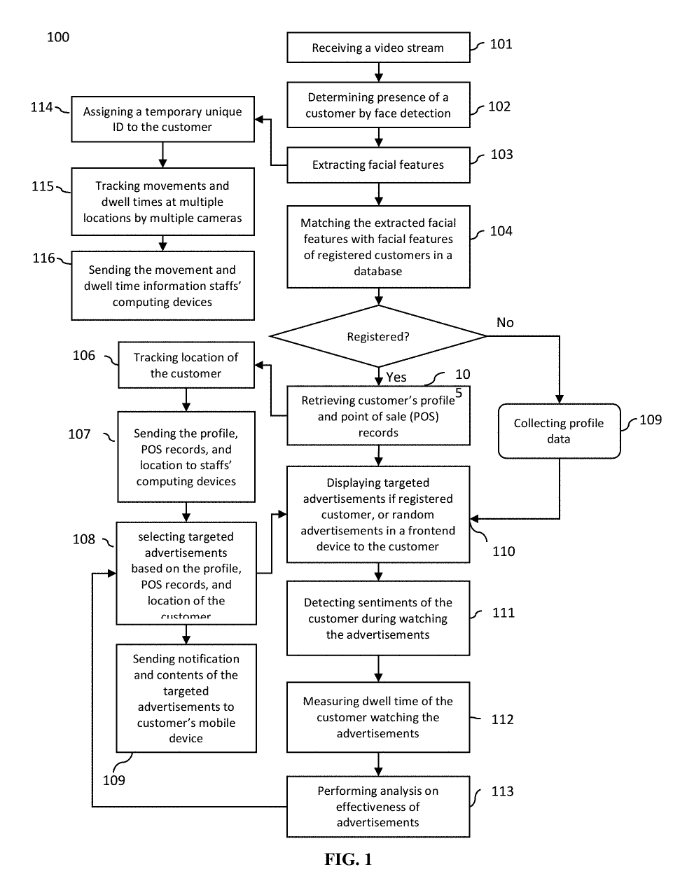

A flowchart of an automatic identification and tracking method 100 in accordance to one embodiment of the present invention is depicted in FIG. 1. The automatic identification and tracking method comprises Step 101: receiving a video stream from a camera installed in a premise, such as a shopping mall or retail store; Step 102: determining presence of a customer by face detection in the video stream; Step 103: extracting facial features of the customer; Step 104: matching the extracted facial features of the customer with previously registered customers' facial feature records in a database to determine whether the customer is registered customer (a VIP or a regular customer); Step 105: retrieving profile, which includes, but not limited to, demographical data, and POS records (e.g. including purchase history) of the customer if the customer is previously registered; Step 106: tracking location of the customer based on the location of the camera; Step 107: sending the retrieved profile, POS records, and tracked location of the customer to one or more computing devices configured to be used by sales/service staffs; Step 108: selecting from a plurality of pre-defined advertisements one or more targeted advertisements based on the retrieved profile, POS records, and tracked location of the customer; and Step 109: sending notification and contents of the targeted advertisements to a mobile communication device of the customer.

The selection of targeted advertisements can be based on the featured products/services in the targeted advertisements that are determined to be relevant to one or more of the retrieved profile, POS records, and tracked location of the customer. For example, in the case where the demographical data indicates female in her late twenties with a recent purchase of a baby stroller and a tracked location of infant food section of the store, a selection of targeted advertisements featuring baby formulas is resulted. In accordance to one embodiment, machine learning techniques are employed in targeted-advertisements selection. One such machine learning techniques makes use of historical data of POS records and profiles of a plurality of registered customers, and compares with the present customer's profile to identify similarities and patterns of purchases and in turn selects the targeted advertisements accordingly.

In accordance to one embodiment of the present invention, the aforesaid Step 102 and Step 103 are performed using the face recognition methods and systems as disclosed and claimed in U.S. patent application Ser. No. 15/727,717.

In accordance to another embodiment of the present invention, the automatic identification and tracking method further comprises Step 109: collecting the profile, including at least demographical data, of the customer if the customer is not a registered customer. In yet another embodiment of the present invention, the automatic identification and tracking method further comprises Step 110: if the customer is a registered customer, displaying the targeted advertisements in a frontend device to the customer, otherwise, displaying random advertisements in the frontend device to the customer; Step 111: detecting the sentiments of the customer watching the advertisements being displayed in the frontend device; Step 112: measuring a dwell time of the customer watching the advertisements; and Step 113: determining the effectiveness of the advertisements based on the detected sentiments and measured dwell time of the customer. For example, if a pleasant sentiment, i.e. physical display of positive emotions (including smile, laugh, giggle, and neutral emotion), is detected when a particular advertisement, type of advertisement, or advertisement of certain product or service is on display, the advertisement is considered to be effective. For another example, if the measured dwell time for a particular advertisement, type of advertisement, or advertisement of certain product or service on display is longer than a threshold dwell time (e.g. 10 seconds), the advertisement is considered to be effective; otherwise ineffective. For still another example, if an unpleasant sentiment, i.e. physical display of distasteful emotions (including frown and indifferent emotion) is detected when a particular advertisement, type of advertisement, or advertisement of certain product or service is on display, the advertisement is considered to be ineffective.

Therefore, the effectiveness of an advertisement to a customer is a function of detected sentiments and dwell time of the customer, which can be represented by:

E[Advertisement 1]=f(sentiments, dwell time)

In accordance to another embodiment, the advertisement effectiveness information associated with the customer are recorded. Subsequent selection of targeted advertisements can then be based on the historical records of effectiveness information of types of advertisement and/or advertisement of certain products or services in addition to the retrieved profile, POS records, and tracked location of the customer.

In accordance to another aspect of the present invention, the automatic identification and tracking method further comprises utilizing a plurality of cameras installed at various locations in the premise. The various locations include, but not limited to, advertisement displays, signage devices, merchandise shelves, display counters, entrances, and exits. Once a customer is first captured by one of the cameras in Step 102 and her facial features extracted in Step 103, regardless of whether or not she is previously identified or registered, the customer is assigned a temporary unique identifier in Step 114. The customer is tracked by the plurality of cameras as she roams around the premise with information including path of movement and dwell time at each location recorded in Step 115. This information is then sent to the one or more computing devices configured to be used by sales/service staffs, and analyzed for the customer's interests in goods and services and shopping preferences in Step 116. Consequently, the staffs can make use of the analysis results to better market goods and services, and provide a personalized shopping experience to each customer.

In various embodiments of the present invention, the automatic identification and tracking method preferably comprises dynamically controlling the lighting for capturing of the video streams by the digital video cameras so as to maintain high face recognition accuracy.

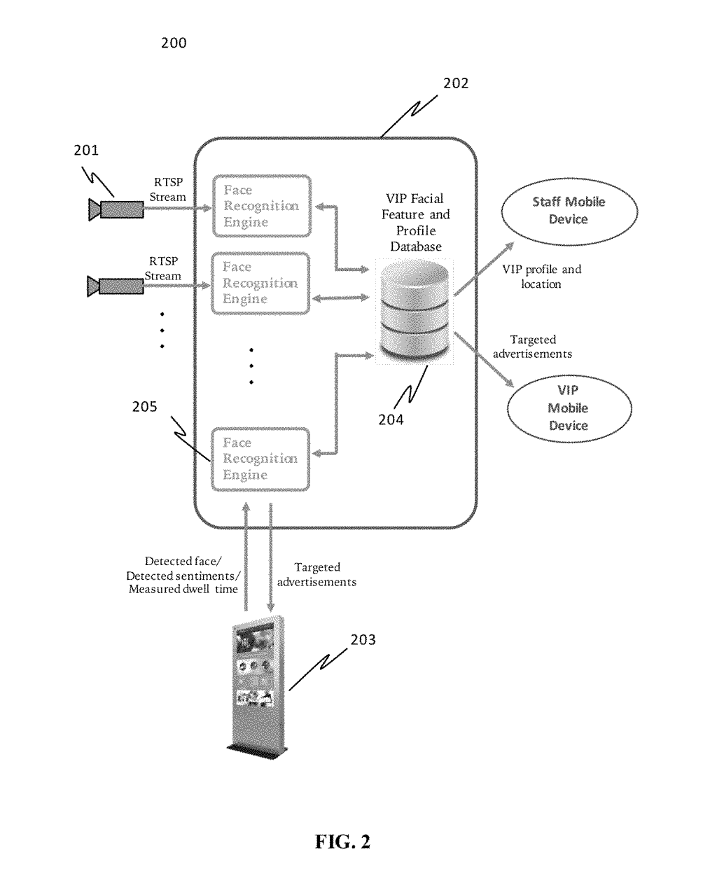

Referring to FIG. 2. In one embodiment of the present invention, an automatic identification and tracking system 200 comprises at least one camera 201 for capturing video streams; an identification and tracking server 202 for identifying whether a customer is a registered customer (a VIP or a regular customer), retrieving profile, including demographical data, and POS records (e.g. including purchase history) of the customer, tracking location of the customer, and sending the retrieved profile and tracked location of the customer to a plurality of computing devices configured to be used by sales/service staffs; and at least one frontend device 203 for displaying a plurality of advertisements to the customer, collecting profile, including at least demographical data, of the customer through a user interface, which can be a graphical user interface displayed in an electronic touch screen of the frontend device 203. The identification and tracking server 202, working in conjunction with camera 201, is further configured for capturing and detecting sentiments of the customer watching the advertisements, measuring a dwell time of watching the advertisements by the customer, and performing analysis on effectiveness of the advertisements from the detected sentiments and measured dwell times. The identification and tracking server 202 comprises at least one storage media 204 for storing a database of facial features, demographical data, profiles, and types (e.g. VIP or regular) of registered customers, recorded sentiments and dwell times of the customers with references to the advertisements watched by the customers, and the associated advertisement effectiveness analysis results; at least one face recognition engine 205 for determining presence of customer, extracting facial features, matching the extracted facial features with registered customers' facial feature records in the database, detecting sentiments, meaning dwell times, and analyzing advertisement effectiveness.

In accordance to various embodiments of the present invention, the cameras 201 are built-in or peripheral cameras of the frontend devices 203. In one embodiment of the present invention, the frontend devices 103 comprise at least one electronic display. In accordance to one embodiment of the present invention, the cameras 201 and the frontend devices 203 are positioned strategically at advertisement displays, merchandise shelves, display counters, entrances and exits of the premise. In accordance to one embodiment, the frontend device 203 is a signage device, such as a kiosk or an electronic billboard, having an electronic display. In accordance to various embodiments of the present invention, the computing device configured to be used by sales/service staffs can be a personal computer, laptop computer, mobile computing device such as “smartphone” and “tablet” computer, or kiosk configured to execute machine instructions that communicate with identification and tracking server 202 and render a graphical user interface to display data received from the identification and tracking server 202 to and interact with the sales/service staff. In accordance to various embodiments of the present invention, the mobile communication device of the customer can be a mobile computing device such as “smartphone” and “tablet” computer.

In accordance to various embodiments of the present invention, the automatic identification and tracking system comprises at least machine instructions for rendering and controlling a graphical user interface displayed on the electronic display, machine instructions for controlling the camera for capturing images and videos, and machine instructions for performing the customer identification and tracking; wherein the machine instructions can be executed using general purpose or specialized computing devices, computer processors, or electronic circuitries including, but not limited to, digital signal processors (DSP), application specific integrated circuits (ASIC), field programmable gate arrays (FPGA), and other programmable logic devices.

The embodiments disclosed herein may be implemented using general purpose or specialized computing devices, computer processors, or electronic circuitries including but not limited to digital signal processors (DSP), application specific integrated circuits (ASIC), field programmable gate arrays (FPGA), and other programmable logic devices configured or programmed according to the teachings of the present disclosure. Computer instructions or software codes running in the general purpose or specialized computing devices, computer processors, or programmable logic devices can readily be prepared by practitioners skilled in the software or electronic art based on the teachings of the present disclosure.

In various embodiments, the present invention includes computer storage media having computer instructions or software codes stored therein which can be used to program computers or microprocessors to perform any of the processes of the present invention. The storage media can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. An automatic identification and tracking method comprises:
receiving one or more video streams from one or more cameras;
determining presence of a customer by face detection, executed by a first processor, in the video streams;
conducting, by a second processor, anti-spoofing tests on the video streams including:
a scan line detection test for detecting Moire patterns created by an overlapping of digital grid from a digital media display and grid of the camera image sensor, wherein the video streams contain a spoof image if Moire patterns are detected;
a specular reflection detection test for detecting one or more specular reflection features of a mirror or reflective surface from the video streams, wherein the video streams contain a spoof image if one or more specular reflection features of a mirror or reflective surface are detected; and
a chromatic moment and color diversity feature analysis test, wherein the chromatic moment and color diversity analysis comprises:
extracting chromatic features and color histogram features from the video streams in both HSV and RGB spaces; and
classifying the extracted chromatic features and color histogram features to determine whether the video streams contain a spoof image;
wherein color diversity of the video streams is analyzed to determine whether the video streams contain a spoof image;
extracting facial features of the customer;
matching the extracted facial features of the customer with registered customers' facial feature records in a database;
determining the customer is a registered customer based on whether the extracted facial features of the customer match with facial features of one of the registered customers' facial feature records in the database;
if the customer is a registered customer:
retrieving one or more of profile data and point of sale (POS) records of the customer, and displaying one or more targeted advertisements associated with the demographical data of the customer in a frontend device to the customer;
else if the customer is not a registered customer:
displaying one or more random advertisements in a frontend device to the customer;
detecting a plurality of sentiments of the customer watching each of the advertisements;
measuring a first dwell time of the customer watching each of the advertisements; and
determining the advertisements' effectiveness based on a function of detected sentiments and measured first dwell time of the customer.

2. The method of claim 1, further comprises collecting demographical data of the customer if the customer is not a registered customer.

3. The method of claim 1, further comprises sending the one or more retrieved profile data and POS records of the customer to one or more computing devices configured to be used by staffs.

4. The method of claim 1, further comprises:
tracking one or more locations of the customer based on locations of the one or more cameras recording video streams having the customer's presence;
measuring a second dwell time of the customer staying in each of the locations of the customer;
determining the customer's interests in goods and services and shopping preferences based on each of the second dwell times; and
sending the customer's interests in goods and services and shopping preferences to one or more mobile devices configured to be used by staffs.

5. The method of claim 1, further comprises:
selecting the one or more targeted advertisements from a plurality of pre-defined advertisements based on the retrieved profile data, POS records, and historical records of the targeted advertisements' effectiveness.

6. An automatic identification and tracking system comprising:
one or more cameras for capturing one or more video streams;
an identification and tracking server configured for identifying whether a customer is a registered customer, retrieving one or more profile data and POS records of the customer, and determining effectiveness of each of one or more advertisements; and
one or more frontend devices for displaying the one or more advertisements to the customer, collecting demographical data of the customer;
wherein the identification and tracking server comprises:
at least one storage media for storing a database of registered customers' facial feature records and profile data of registered customers; and
at least one face recognition engine configured for:
determining presence of the customer,
extracting facial features of the customer and matching the extracted facial features of the customer with registered customers' facial feature records in the database,
detecting sentiments of the customer watching each of the advertisements,
measuring a first dwell time of watching each of the advertisements by the customer, and
conducting anti-spoofing tests on the video streams including:
a scan line detection test for detecting Moire patterns created by an overlapping of digital grid from a digital media display and grid of the camera image sensor, wherein the video streams contain a spoof image if Moiré patterns are detected;
a specular reflection detection test for detecting one or more specular reflection features of a mirror or reflective surface from the input image, wherein the video streams contain a spoof image if one or more specular reflection features of a mirror or reflective surface are detected; and
a chromatic moment and color diversity feature analysis test, wherein the chromatic moment and color diversity analysis comprises:
extracting chromatic features and color histogram features from the video streams in both HSV and RGB spaces; and
classifying the extracted chromatic features and color histogram features to determine whether the video streams contain a spoof image;
wherein the color diversity of the input image is analyzed to determine whether the video streams contain a spoof image.

7. The system of claim 6, wherein the cameras are built-in or peripheral cameras of the frontend devices.

8. The system of claim 6, wherein the identification and tracking server is further configured for sending the one or more retrieved profile data and POS records of the customer to one or more mobile devices configured to be used by staffs.

9. The system of claim 6,
wherein the identification and tracking server is further configured for:
tracking one or more locations of the customer based on locations of the one or more cameras recording video streams having the customer's presence;
measuring a second dwell time of the customer staying in each of the locations of the customer;
determining the customer's interests in goods and services and shopping preferences based on each of the second dwell times;
sending the customer's interests in goods and services and shopping preferences to one or more mobile devices configured to be used by staffs.

10. The system of claim 6,
wherein the identification and tracking server is further configured for selecting one or more targeted advertisements from a plurality of pre-defined advertisements based on the retrieved profile data, POS records, and historical records of the targeted advertisements' effectiveness; and
wherein the one or more advertisements displayed by the frontend devices are the targeted advertisements.

11-12. (canceled)
